(19) United States
(12) Patent Application Publication
(10) Pub. No.: US 2024/0323802 A1
(43) Pub. Date: Sep. 26, 2024

(54) COMMUNICATION APPARATUS, TERMINAL APPARATUS, COMMUNICATION SYSTEM, AND COMMUNICATION CONTROL METHOD

(71) Applicant: SHARP KABUSHIKI KAISHA, Sakai City, Osaka (JP)

(72) Inventors: KATSUTOSHI ISHIKURA, Sakai City, Osaka (JP); ATSUSHI YAMAZAKI, Sakai City, Osaka (JP); MAKOTO YAMAMOTO, Sakai City, Osaka (JP); RYOKI HINATA, Sakai City, Osaka (JP); HIDEAKI SHINMEI, Sakai City, Osaka (JP); Atsuko KUNISADA, Sakai City, Osaka (JP)

(21) Appl. No.: 18/578,061

(22) PCT Filed: Feb. 17, 2022
(86) PCT No.: PCT/JP2022/006307

§ 371 Date: Jan. 10, 2024

(30) Foreign Application Priority Data
Jul. 12, 2021 (JP) 2021-114851

(51) Int. Cl. H04W 40/22; H04W 28/02; H04W 76/10

(52) U.S. Cl. CPC H04W 40/22; H04W 28/0268; H04W 76/10

(57) ABSTRACT

A communication apparatus includes a first communication unit configured to perform first communication using a first communication method, a second communication unit configured to perform second communication using a second communication method, and a controller. The controller performs the second communication via the second communication unit with a terminal apparatus supporting both of the first communication method and the second communication method and not performing communication using the first communication method, to acquire connection configuration information in the first communication method. The controller performs the first communication with a device other than the terminal apparatus via the first communication unit, using a configuration according to the connection configuration information.

### TECHNICAL FIELD

The disclosure relates to a communication apparatus, a terminal apparatus, a communication system, a communication control method, and the like. This application claims priority based on JP 2021-114851 filed on Jul. 12, 2021, the contents of which are incorporated herein by reference.

### BACKGROUND ART

Various methods related to communication control have hitherto been known. For example, PTL 1 discloses a method of causing Quality of Service (QOS) in a downlink of a network to be reflected in an uplink.

In the 3rd Generation Partnership Project (3GPP), system architecture of a 5G System (5GS) being a fifth generation (5G) mobile communication system has been studied, and support of new procedures and new functions has been discussed. The 5GS is disclosed in NPL 1, for example.

### CITATION LIST

### Patent Literature

PTL 1: JP 2019-532582 A

### Non Patent Literature

NPL 1: 3GPP TS 38.300 V16.4.0 (2020-12); Technical Specification Group Radio Access Network; NR; NR and NG-RAN Overall Description; Stage 2 (Release 16)

### SUMMARY

### Technical Problem

Even in a case that a terminal supports 5G, the terminal may connect to a 5G network via WiFi. In this manner, in a case that a terminal supporting a first communication method and a second communication method connects to another apparatus using the second communication method, and such another apparatus performs communication in accordance with the first communication method, a terminal apparatus 100 cannot fully use functions of the first communication method. PTL 1 concerns a method of synchronizing QoS between an uplink and a downlink of a given User Equipment (UE), and does not take a connection mode as described above into consideration. NPL 1 relates to functions of 5G, and does not, expectedly, take a connection mode as described above into consideration.

According to some aspects of the present disclosure, a communication apparatus, a terminal apparatus, a communication system, a communication control method, and the like that can appropriately use functions of a first communication method can be provided even in a case that a second communication method is used.

### Solution to Problem

An aspect of the present disclosure relates to a communication apparatus including: a first communication unit configured to perform first communication using a first communication method; a second communication unit configured to perform second communication using a second communication method different from the first communication method; and a controller configured to control the first communication unit and the second communication unit, wherein the controller performs the second communication via the second communication unit with a terminal apparatus supporting both of the first communication method and the second communication method and not performing communication using the first communication method, to acquire connection configuration information in the first communication method, and the controller performs the first communication with a device other than the terminal apparatus via the first communication unit, using a configuration according to the connection configuration information.

Another aspect of the present disclosure relates to a terminal apparatus including: a first terminal communication unit configured to perform first communication using a first communication method; a second terminal communication unit configured to perform second communication with a communication apparatus, using a second communication method different from the first communication method; and a terminal controller configured to control the first terminal communication unit and the second terminal communication unit, wherein in a state in which the first communication using the first terminal communication unit is not performed, the terminal controller transmits connection configuration information to be used in a case that the communication apparatus performs the first communication with another apparatus to the communication apparatus via the second terminal communication unit.

Yet another aspect of the present disclosure relates to a communication system including: a communication apparatus configured to perform communication using a first communication method and a second communication method; and a terminal apparatus configured to performing communication using the first communication method and the second communication method, wherein the communication apparatus performs second communication using the second communication method with the terminal apparatus not performing communication using the first communication method, to acquire connection configuration information in the first communication method, and the communication apparatus performs first communication using the first communication method with a device other than the terminal apparatus, using a configuration according to the connection configuration information.

Yet another aspect of the present disclosure relates to a communication control method in a communication apparatus capable of performing first communication using a first communication method and second communication using a second communication method different from the first communication method, the communication control method including: performing the second communication using the second communication method with a terminal apparatus supporting both of the first communication method and the second communication method and not performing communication using the first communication method, and thereby acquiring connection configuration information in the first communication method; and performing the first communication with a device other than the terminal apparatus, using a configuration according to the connection configuration information.

### BRIEF DESCRIPTION OF DRAWINGS

FIG. 1A is a configuration example of a communication system.

FIG. 1B is a configuration example of a case that a terminal apparatus directly performs communication in accordance with a first communication method.

FIG. 2 is a configuration example of the terminal apparatus.

FIG. 3 is a configuration example of a communication apparatus.

FIG. 4 is a flowchart illustrating processing in the terminal apparatus.

FIG. 5 is a flowchart illustrating processing in the communication apparatus.

FIG. 6 is a flowchart illustrating processing in the communication apparatus.

FIG. 7 is a diagram illustrating a flow of processing in the communication system.

FIG. 8 is a diagram illustrating a flow of processing of a case that the terminal apparatus determines second connection configuration information.

FIG. 9 is a diagram illustrating a flow of processing of a case that the communication apparatus determines the second connection configuration information.

FIG. 10 is another configuration example of the communication apparatus.

FIG. 11 is an example of information stored by a storage unit of the communication apparatus.

FIG. 12 is a flowchart illustrating processing in the communication apparatus.

FIG. 13 is a diagram illustrating a flow of processing in the communication system.

FIG. 14 is an explanatory diagram of a method for displaying objects according to connection states in the terminal apparatus.

FIG. 15 is an explanatory diagram of a method for displaying objects according to connection states in the terminal apparatus.

### DESCRIPTION OF EMBODIMENTS

The present embodiment will be described below with reference to the drawings. In the drawings, the same or equivalent elements are denoted by the same reference numerals and duplicate description will be omitted. Note that the present embodiment described below is not to unreasonably limit the contents described in Claims. Not necessarily all of the configurations described in the present embodiment are essential configuration requirements of the present disclosure.

### 1. First Embodiment

### 1.1 System Configuration Example

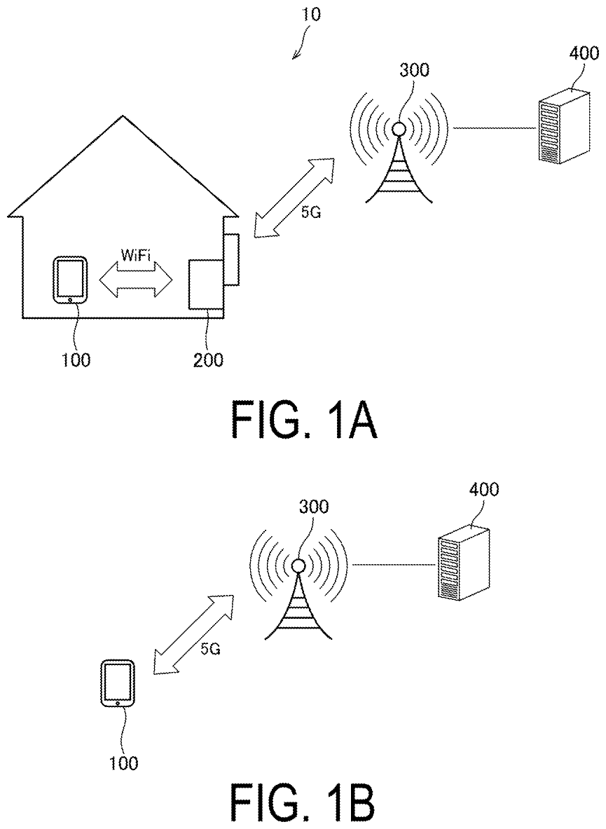

FIG. 1A is a diagram illustrating an example of a configuration of a communication system 10 according to the present embodiment. The communication system 10 includes a terminal apparatus 100 and a communication apparatus 200. The communication apparatus 200 is an apparatus capable of performing communication on a Local Area Network (LAN) side and communication on a Wide Area Network (WAN) side. The communication apparatus 200 is connected to the terminal apparatus 100 on the LAN side. The communication apparatus 200 is connected to a core network 400 on the WAN side via a base station 300.

For example, each of the terminal apparatus 100 and the communication apparatus 200 can perform radio communication in accordance with a communication method defined in Institute of Electrical and Electronics Engineers (IEEE) 802.11. More specifically, the terminal apparatus 100 and the communication apparatus 200 may be connected using WiFi (trade name). Note that connection between the terminal apparatus 100 and the communication apparatus 200 is not limited to WiFi. For example, the terminal apparatus 100 and the communication apparatus 200 may be connected using a wired network such as Ethernet, or may be connected using a Universal Serial Bus (USB).

The communication apparatus 200 is capable of communication using a communication method different from the communication method used in connection with the terminal apparatus 100. For example, the communication apparatus 200 may be a device capable of communication in accordance with a communication method used in mobile communication. More specifically, the communication apparatus 200 performs communication using a 5G System (5GS). For example, the communication apparatus 200 is capable of communication of a Stand Alone (SA) method, the base station 300 is an NR base station (gNB) of a 5G method, and the core network 400 is a 5G core network. The 5G core network is hereinafter also referred to as a 5GC. Processing of the present embodiment to be described later may be performed in a case that the communication apparatus 200 performs communication of the SA method. Note that the communication apparatus 200 may connect to an Evolved Packet Core (EPC) using Long Term Evolution (LTE) or a 5G Non-Stand Alone (NSA) method, or may perform communication of 3G using Wideband Code Division Multiple Access (WCDMA; WCDMA is a trade name) or the like.

For example, the communication apparatus 200 is a Customer Premises Equipment (CPE) installed by a user of the terminal apparatus 100 at their home. As illustrated in FIG. 1A, in an environment in which WiFi connection with the communication apparatus 200 can be performed, the terminal apparatus 100 can connect to the WAN side via the communication apparatus 200. For example, the terminal apparatus 100 can perform transmission and/or reception of data to and/or from any data network via a mobile communication network such as 5G. The data network in this case refers to a network outside of the 5GC, and may be the Internet or the like, for example.

FIG. 1B is a diagram illustrating an example of a case that the terminal apparatus 100 according to the present embodiment performs communication without using the communication apparatus 200. As illustrated in FIG. 1B, the terminal apparatus 100 is connected to the core network 400 via the base station 300. In other words, the terminal apparatus 100 may be a device capable of communication of 5G in addition to WiFi connection. For example, the terminal apparatus 100 performs communication using WiFi at home or the like where the communication apparatus 200 is installed, and performs communication using 5G at a place outside the home or the like which is away from the communication apparatus 200.

In a case that the terminal apparatus 100 supporting 5G is connected to the 5GC without using communication of another method such as WiFi (FIG. 1B), the terminal apparatus 100 can utilize 5G capabilities at the maximum. For example, the terminal apparatus 100 can use functions of the 5GC, such as high-capacity communication, ultra-low latency communication, and ultra-multiple access communication. Specifically, the terminal apparatus 100 performs communication using an appropriate network slice or priority control in communication with a 5G network. In contrast, in the configuration illustrated in FIG. 1A, it is the communication apparatus 200, not the terminal apparatus 100, that directly performs communication using 5G. The method of the present embodiment enables the terminal apparatus 100 to utilize the 5G capabilities also in the communication system 10 illustrated in FIG. 1A. Specific methods will be described below.

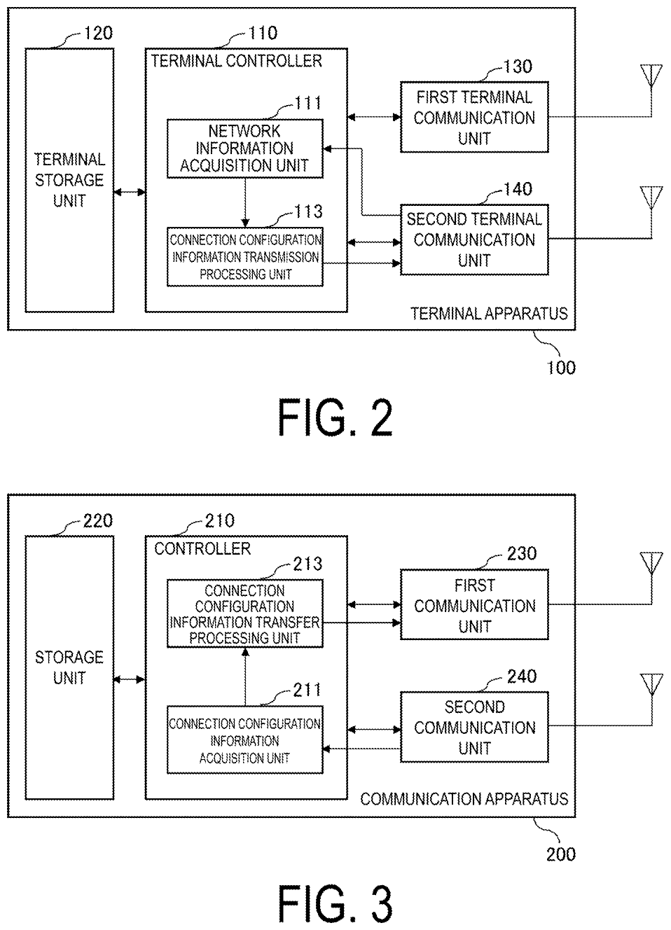

FIG. 2 is a block diagram illustrating a configuration of the terminal apparatus 100. The terminal apparatus 100 includes a terminal controller 110, a terminal storage unit 120, a first terminal communication unit 130, and a second terminal communication unit 140. Note that the configuration of the terminal apparatus 100 is not limited to that of FIG. 2, and modifications can be made by, for example, omitting a part of the configuration and adding another configuration. The modifications, such as omission and addition, to configurations can also be made to other figures such as FIG. 3.

The terminal controller 110 controls each unit of the terminal apparatus 100, including the first terminal communication unit 130 and the second terminal communication unit 140. The terminal controller 110 of the present embodiment includes the following hardware. The hardware can include at least one of a circuit for processing a digital signal and a circuit for processing an analog signal. For example, the hardware can include one or multiple circuit apparatuses or one or multiple circuit elements implemented in a circuit substrate. Each of the one or multiple circuit apparatuses is an Integrated Circuit (IC), a field-programmable gate array (FPGA), or the like, for example. Each of the one or multiple circuit elements is a resistor, a capacitor, or the like, for example.

The terminal controller 110 may be implemented with the following processor. The terminal apparatus 100 of the present embodiment includes a memory that stores information and the processor that operates based on the information stored in the memory. The information is a program, various pieces of data, and the like, for example. The processor includes hardware. The processor can use various processors, such as a Central Processing Unit (CPU), a Graphics Processing Unit (GPU), and a Digital Signal Processor (DSP). The memory may be a semiconductor memory such as a Static Random Access Memory (SRAM), a Dynamic Random Access Memory (DRAM), and a flash memory, may be a resistor, may be a magnetic storage apparatus such as a hard disk apparatus (Hard Disk Drive (HDD)), or may be an optical storage apparatus such as an optical disc apparatus. For example, the memory stores an instruction that can be read by a computer, and with the processor performing the instruction, the function of the terminal controller 110 is implemented as processing. The instruction in this case may be an instruction of a set of instructions constituting a program, or may be an instruction for indicating operation to a hardware circuit of the processor.

The terminal controller 110 includes a network information acquisition unit 111 and a connection configuration information transmission processing unit 113. The network information acquisition unit 111 performs processing of acquiring network information from the communication apparatus 200 via the second terminal communication unit 140. The network information refers to information for identifying a communication method of the communication apparatus 200 on the WAN side. The connection configuration information transmission processing unit 113 transmits connection configuration information indicating a configuration in communication of the communication apparatus 200 on the WAN side to the communication apparatus 200 via the second terminal communication unit 140.

The terminal storage unit 120 is a working area of the terminal controller 110, and stores various pieces of information. The terminal storage unit 120 can be implemented with various memories, and each of such memories may be a semiconductor memory such as an SRAM, a DRAM, a Read Only Memory (ROM), and a flash memory, may be a resistor, may be a magnetic storage apparatus, or may be an optical storage apparatus.

The terminal storage unit 120 may store information in which an application program to be performed in the terminal apparatus 100 and connection configuration information indicating a configuration of communication in the application program are associated with each other, for example. The application program is hereinafter also simply referred to as an application. In this case, based on an application to be performed and the information stored in the terminal storage unit 120, the connection configuration information transmission processing unit 113 can acquire the connection configuration information corresponding to the application.

The first terminal communication unit 130 is an interface for performing communication via a network, and includes an antenna, a radio frequency (RF) circuit, and a baseband circuit, for example. The first terminal communication unit 130 operates in accordance with control performed by the terminal controller 110. The first terminal communication unit 130 may include a processor for communication control, which is different from the terminal controller 110. The first terminal communication unit 130 performs communication using a first communication method.

The first communication method is a communication method used in the 5G System (5GS), for example. For example, as illustrated in FIG. 1B, in a case that the communication apparatus 200 is not present, the first terminal communication unit 130 performs communication with the core network 400 being a 5GC via the base station 300.

The second terminal communication unit 140 is an interface for performing communication via a network, and includes an antenna, an RF circuit, and a baseband circuit, for example. The second terminal communication unit 140 operates in accordance with control performed by the terminal controller 110. The second terminal communication unit 140 may include a processor for communication control, which is different from the terminal controller 110.

The second terminal communication unit 140 performs communication using a second communication method. The second communication method is a communication method different from the first communication method, and is a communication method using WiFi as described above with reference to FIG. 1A, for example. For example, in a case that the communication apparatus 200 is present, the second terminal communication unit 140 performs communication with the communication apparatus 200.

FIG. 3 is a block diagram illustrating a configuration of the communication apparatus 200. The communication apparatus 200 includes a controller 210, a storage unit 220, a first communication unit 230, and a second communication unit 240.

The controller 210 controls each unit of the terminal apparatus 100, including the first communication unit 230 and the second communication unit 240. The controller 210 of the present embodiment includes hardware including at least one of a circuit for processing a digital signal and a circuit for processing an analog signal. For example, the hardware can include one or multiple circuit apparatuses or one or multiple circuit elements implemented in a circuit substrate.

The controller 210 can be implemented with various processors, such as a CPU, a GPU, and a DSP. The communication apparatus 200 includes a memory that stores information and the processor that operates based on the information stored in the memory. The memory stores an instruction that can be read by a computer, and with the processor performing the instruction, the function of the controller 210 is implemented as processing.

The controller 210 includes a connection configuration information acquisition unit 211 and a connection configuration information transfer processing unit 213. The connection configuration information acquisition unit 211 performs processing of acquiring the connection configuration information from the connection configuration information transmission processing unit 113 of the terminal apparatus 100 via the second communication unit 240. The connection configuration information transfer processing unit 213 performs communication of the first communication unit 230 on the WAN side, using the acquired connection configuration information. Details of processing in each unit of the controller 210 will be described later.

The storage unit 220 is a working area of the controller 210, and stores various pieces of information. The storage unit 220 can be implemented with various memories, and each of such memories may be a semiconductor memory, may be a resistor, may be a magnetic storage apparatus, or may be an optical storage apparatus.

The first communication unit 230 is an interface for performing communication via a network, and includes an antenna, an RF circuit, and a baseband circuit, for example. The first communication unit 230 operates in accordance with control performed by the controller 210. The first communication unit 230 may include a processor for communication control, which is different from the controller 210.

The first communication unit 230 performs first communication using the first communication method. The first communication method is a communication method used in the 5GS as described above with reference to FIG. 1A, for example. For example, the first communication unit 230 performs communication with the core network 400 being a 5GC via the base station 300.

The second communication unit 240 is an interface for performing communication via a network, and includes an antenna, an RF circuit, and a baseband circuit, for example. The second communication unit 240 operates in accordance with control performed by the controller 210. The second communication unit 240 may include a processor for communication control, which is different from the controller 210.

The second communication unit 240 performs second communication using the second communication method. The second communication method is a communication method different from the first communication method, and is a communication method using WiFi as described above with reference to FIG. 1A, for example. For example, the second communication unit 240 performs second communication with the terminal apparatus 100.

### 1.2 Flow of Processing

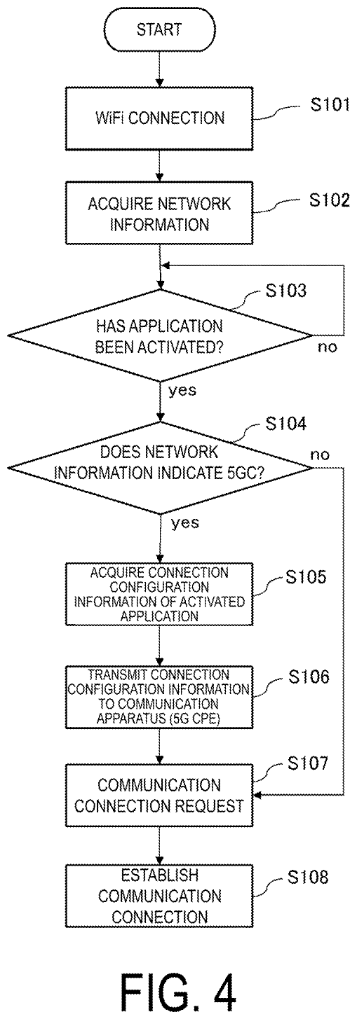

FIG. 4 is a flowchart illustrating processing in the terminal apparatus 100. In a case that the processing is initiated, first, in step S101, the second terminal communication unit 140 performs WiFi connection with the communication apparatus 200. In step S102, the network information acquisition unit 111 acquires network information from the communication apparatus 200 via the second terminal communication unit 140. Through the processing of step S102, the terminal controller 110 of the terminal apparatus 100 can determine which method is used by the communication apparatus 200 as a communication method on the WAN side. For example, the network information is information for identifying which is a connection destination of the communication method of the communication apparatus 200 on the WAN side, among a 5GC, an EPC, 3G, and a wired LAN, as a method for performing communication.

In step S103, the terminal controller 110 determines whether or not an application has been activated in the terminal apparatus 100. The application in this case includes various application programs to be performed in the terminal apparatus 100, and is, in the narrow sense, a program for performing communication processing using a network. In a case that an application is not activated, new communication need not be established, and thus the terminal controller 110 repeats processing of step S103. In other words, the terminal controller 110 stands by without performing processing of step S104 and subsequent steps, until an application is activated.

In a case that an application is activated, in step S104, the terminal controller 110 determines whether the network information indicates connection with a 5GC. In other words, the terminal controller 110 determines the communication method of the communication apparatus 200 on the WAN side connected in step S101, based on the network information acquired in step S102.

In a case that the communication method on the WAN side is a method for performing communication with other than the 5GC (No in step S104), the terminal controller 110 omits processing of steps S105 and S106 and requests the communication apparatus 200 to perform connection establishment in step S107. In this case, in step S108, communication connection without using the connection configuration information is established. For example, the communication apparatus 200 performs communication with an EPC, and transmission and/or reception of data between the terminal apparatus 100 and a data network is performed via the communication apparatus 200 and the EPC.

In a case that the communication apparatus 200 performs connection with a 5GC (Yes in step S104), the terminal controller 110 performs control for utilizing functions of 5G, such as network slicing and QoS control. Specifically, in step S105, the connection configuration information transmission processing unit 113 acquires connection configuration information corresponding to the activated application. For example, as described above, the terminal storage unit 120 stores an application and the connection configuration information appropriate for the application in association with each other. Thus, the connection configuration information transmission processing unit 113 compares the activated application and the information stored in the terminal storage unit 120, and thereby acquires the connection configuration information.

As can be understood from the above description, the connection configuration information of the present embodiment may be information determined according to an application to be performed in the terminal apparatus 100. Whether a communication rate is important, whether low communication latency is important, and whether communication reliability is important are different according to each application. Some applications have difficulty in performing smooth operation without high QoS, the QoS indicating communication quality, and other applications can perform operation with low QoS. With this, by determining the connection configuration information according to an application, communication control optimal for each application can be implemented.

Specifically, the connection configuration information of the present embodiment may be information for determining a network slice in network slicing of the 5GS, or may be information for determining Quality of Service (QOS). In this manner, the functions of the 5GS can be appropriately used based on the connection configuration information.

For example, in the 5GS, owing to virtualization of network functions, multiple logical sections having different features can be operated on the same 5GC. A logical resource section used in separate management and operation of the network functions is referred to as a network slice (hereinafter also simply referred to as a slice). For example, in the 5GC, the following configuration can be employed: a part of C-plane functions, such as a Network Slice Selection Function (NSSF), an Authentication Server Function (AUSF), and a Unified Data Management (UDM), are common to multiple slices, whereas another part of C-plane functions, such as an Access and Mobility management Function (AMF) and a Session Management Function (SMF), and a User Plane Function (UPF) are provided for each slice. Note that various modifications can be made to specific architecture of network slicing by, for example, using a common AFM in multiple slices or providing multiple AUSFs and UDMs. The functions of each Network Function (NF) are disclosed in NPL 1 and the like, and thus detailed description thereof is omitted.

In this case, each slice can be assigned a different feature, and for example, a first slice has a feature appropriate for enhanced Mobile Broadband (eMBB), a second slice has a feature appropriate for Ultra-Reliable and Low Latency Communications (URLLC), and a third slice has a feature appropriate for Massive Internet of Things (MIOT). MIOT may be replaced with massive Machine-Type Communications (mMTC). With a User Equipment (UE) connecting to the 5GC transmitting information for selecting an appropriate slice to the NSSF, communication having a desired feature can be implemented.

The connection configuration information of the present embodiment is Network Slice Selection Assistance Information (NSSAI) being information for determining a slice, for example, and is, in the narrow sense, Single-NSSAI (S-NSSAI). The S-NSSAI includes a Slice/Service Type (SST) and a Slice Differentiator (SD). The SST is numerical data for determining a slice type, and for example, 1 corresponds to eMBB, 2 corresponds to URLLC, and 3 corresponds to MIOT. The SD is used in a case of identifying multiple slices in the same SST.

In the 5GS, QoS control can be performed. For example, in the 5GS, a Protocol Data Unit (PDU) session is used as logical connection from the UE to a data network. One or multiple QoS flows are defined in one PDU session, and QoS is determined for each QoS flow.

The connection configuration information of the present embodiment is information for determining QoS, for example, and may more specifically be a 5G QoS Indicator (5QI). The 5QI is a scalar value, and for example, a given value is associated with a combination of standard QoS characteristics. The scalar value of the 5QI is hereinafter referred to as a 5QI value. For example, a resource type, a priority level, an upper limit value of packet forwarding delay, an upper limit of a packet error rate, and the like are associated with each 5QI value. The resource type is information for identifying a type, such as a “guaranteed bit rate” type, a “delay critical guaranteed bit rate” type, and a “non-guaranteed bit rate” type. The priority level is priority in scheduling of assignment of forwarding resources between QoS flows, and as its value is lower, the priority is higher.

For example, in step S105, the connection configuration information transmission processing unit 113 acquires at least one of the S-NSSAI and the 5QI value, according to the application. Then, in step S106, the connection configuration information transmission processing unit 113 transmits the acquired connection configuration information to the communication apparatus 200 via the second terminal communication unit 140.

In step S107, the terminal controller 110 requests establishment of first communication based on the transmitted connection configuration information. Note that, as described above with reference to FIG. 1A, the terminal apparatus 100 in this case does not directly connect to the base station 300 and the core network 400. Thus, the terminal controller 110 requests the communication apparatus 200 to establish the first communication. The communication apparatus 200 performs connection with the 5GC in response to the request, and in step S108, communication connection based on the connection configuration information is thereby established.

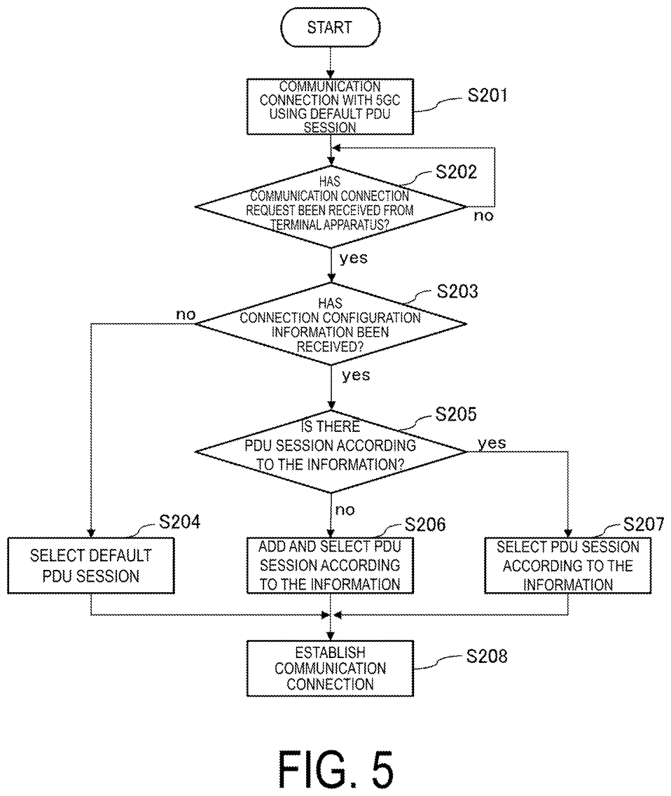

FIG. 5 is a flowchart illustrating processing in the communication apparatus 200. Specifically, FIG. 5 is a diagram illustrating processing of a case that information, such as the S-NSSAI, for determining a network slice is used as the connection configuration information. In step S201, it is assumed that the controller 210 performs communication connection with the 5GC via the first communication unit 230. In the communication connection in this case, a default PDU session is used.

In step S202, the controller 210 determines whether a communication connection request has been received from a given terminal. The communication connection request in this case is a request transmitted in a case that a terminal that has established WiFi connection performs communication with a device present in the communication apparatus 200 on the WAN side via the communication apparatus 200, for example. The given terminal may be the terminal apparatus 100 supporting the method of the present embodiment, and the communication connection request in this case is the request described above using step S107 of FIG. 4. The given terminal may be a terminal not supporting the method of the present embodiment. In any case, for example, with the given terminal activating a new application, the communication connection request is transmitted in a case that communication with a device on the WAN side is required, and the processing is determined as Yes in step S202. In a case that the communication connection request has not been received, the controller 210 continues the processing of step S202. In other words, the controller 210 stands by without performing processing of step S203 and subsequent steps, until receiving the communication connection request.

In a case that the communication connection request has been received, in step S203, the connection configuration information acquisition unit 211 determines whether the connection configuration information has been received. In a case that the terminal that has transmitted the communication connection request is the terminal apparatus 100 according to the present embodiment, as described above with reference to FIG. 4, the connection configuration information may be transmitted to the communication apparatus 200 (Step S106) before the communication connection request illustrated in step S107. For example, the terminal apparatus 100 has acquired information indicating the 5GC as the network information, and has transmitted the connection configuration information for performing the first communication using a slice appropriate for the activated application. As described above, for example, in a case that a slice different from a default slice needs to be used, the terminal apparatus 100 has transmitted the connection configuration information, and the connection configuration information acquisition unit 211 has received the connection configuration information in a case of determining Yes in step S202. Note that the processing of step S106 and step S107 may be performed together, in a manner in which the connection configuration information is included in the communication connection request, for example.

In a case that the connection configuration information has not been received, the terminal that has transmitted the communication connection request may not support the method of the present embodiment, or that the application of the terminal apparatus 100 may not require a special slice. For example, in a case that the terminal that has transmitted the communication connection request does not support the method of the present embodiment, the terminal does not perform the processing of step S106 of FIG. 4, and thus transmits the communication connection request without the connection configuration information. As a result, the controller 210 determines No in step S203. In this case, in step S204, the controller 210 selects a PDU session established by default. In step S208, the first communication unit 230 establishes communication connection using the default PDU session. In other words, in a case that communication between the terminal apparatus 100 and a data network is performed, the default PDU session is used in communication between the 5GC and the communication apparatus 200.

In a case that the connection configuration information has been received, the controller 210 performs control of determining a PDU session to be used in the first communication, based on the connection configuration information. Specifically, in step S205, the controller 210 determines whether a PDU session according to the connection configuration information is present. For example, in a case that the connection configuration information is the S-NSSAI, and the S-NSSAI specifies a slice corresponding to URLLC, the controller 210 determines whether the slice corresponding to URLLC is present and whether a PDU session is established in the slice.

In a case that a PDU session is not established, in step S206, the controller 210 performs control of adding a PDU session corresponding to the connection configuration information, and selects the added PDU session. In a case that the slice corresponding to the connection configuration information is present, and an appropriate PDU session has been established, in step S207, the controller 210 selects the PDU session. After the processing of step S206 or step S207, the first communication unit 230 establishes communication connection, using the selected PDU session. In other words, in communication between the 5GC and the communication apparatus 200, the PDU session is determined according to the connection configuration information specified by the terminal apparatus 100.

Note that the above has described an example in which a default PDU session has been established. Note that the communication apparatus 200 may enter an idle state, and in the idle state, even a default PDU session is not established. Thus, in step S204 of FIG. 5, the controller 210 may determine whether or not a default PDU session has been established. In a case that a default PDU session has not been established yet, the controller 210 performs control of adding the default PDU session, and selects the added PDU session. In a case that the default PDU session has been established, as described above, the controller 210 selects the default PDU session.

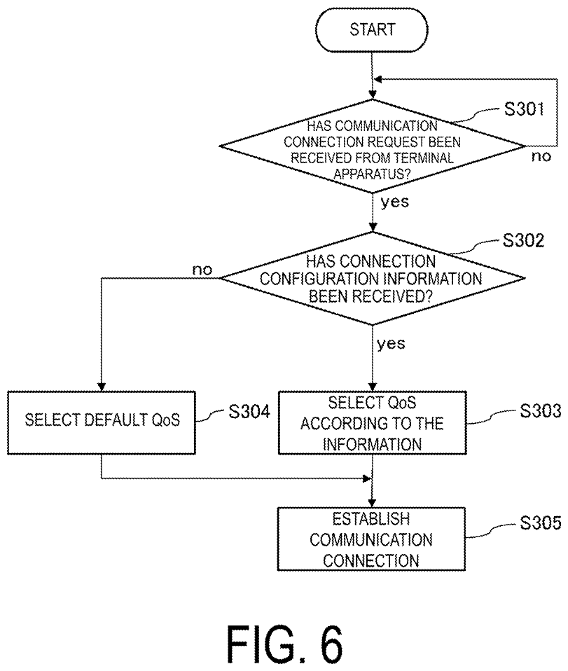

FIG. 6 is another flowchart illustrating processing in the communication apparatus 200. Specifically, FIG. 6 is a diagram illustrating processing of a case that information, such as the 5QI value, for determining QoS is used as the connection configuration information.

In step S301, the controller 210 determines whether the communication connection request has been received from the terminal apparatus 100. For example, with the terminal apparatus 100 activating a new application, the first communication using QoS appropriate for the application is required, and as a result, in a case that the processing of step S107 is performed, the processing is determined as Yes in step S301. In a case that the communication connection request has not been received, the controller 210 continues the processing of step S301.

In a case that the communication connection request has been received, in step S302, the connection configuration information acquisition unit 211 determines whether the connection configuration information has been received. In a case that the connection configuration information has not been received, the terminal that has transmitted the communication connection request may not support the method of the present embodiment, or that the application of the terminal apparatus 100 may not require special QoS. Thus, in step S304, the controller 210 selects default QoS.

In a case that the connection configuration information has been received, the controller 210 performs control of determining QoS to be used in the first communication, based on the connection configuration information. Specifically, in step S303, the controller 210 selects QoS (for example, the 5QI value) according to the connection configuration information. After the processing of step S303 or step S304, the first communication unit 230 establishes communication connection, using the selected QoS. In other words, in a case that the terminal apparatus 100 has transmitted the connection configuration information, QoS in communication between the 5GC and the communication apparatus 200 is determined according to the connection configuration information. For example, a resource type, a priority level, an upper limit value of packet forwarding delay, an upper limit of a packet error rate, and the like according to the 5QI value being the connection configuration information are configured.

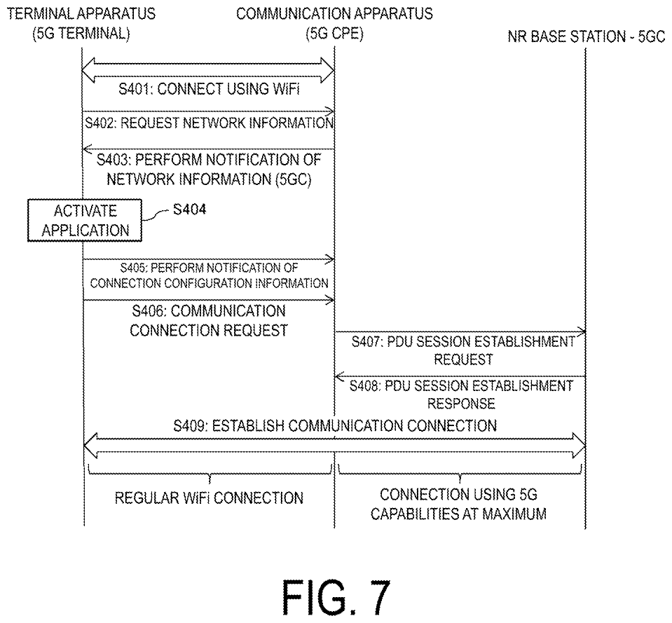

FIG. 7 is a diagram illustrating a flow of communication control between the terminal apparatus 100, the communication apparatus 200, and the 5GS (the base station 300 and the core network 400). Note that, here, an example is assumed in which the connection configuration information is information for determining a slice. The processing in the terminal apparatus 100 and the processing in the communication apparatus 200 are as described above with reference to FIG. 4 and FIG. 5, respectively.

In step S401, the terminal apparatus 100 and the communication apparatus 200 are connected using WiFi. With this, transmission and/or reception of data between the terminal apparatus 100 and the communication apparatus 200 can be performed using WiFi connection.

In step S402, the terminal apparatus 100 requests network information from the communication apparatus 200. In a case that the second communication unit 240 receives an acquisition request for the network information from the terminal apparatus 100, the second communication unit 240 transmits information indicating a communication method on the WAN side to the terminal apparatus 100 as the network information. Here, it is assumed that the first communication unit 230 performs communication on the WAN side, and thus the communication method on the WAN side is specifically the first communication method. Hypothetically, in a case that the communication apparatus 200 connects to an EPC, control methods for a slice and QoS are different from those of the 5GC, and thus information necessary for a connection configuration is also different. In other words, in this case, even in a case that the terminal apparatus 100 supporting 5G transmits the connection configuration information for 5G to the communication apparatus 200, it is difficult for the communication apparatus 200 to use the information for connection on the WAN side. In the present embodiment, by transmitting the network information to the terminal apparatus 100 in advance, whether or not the connection configuration information determined by the terminal apparatus 100 is useful in the communication apparatus 200 can be appropriately determined on the terminal apparatus 100 side.

Here, it is assumed that the communication apparatus 200 can connect to the 5GC, and thus, in step S403, the communication apparatus 200 returns the network information indicating connection to the 5GC. With this, the terminal apparatus 100 determines that the functions of the 5GC can be used in connection of the communication apparatus 200 on the WAN side.

In step S404, the terminal apparatus 100 activates an application. In step S405, the terminal apparatus 100 acquires the connection configuration information according to the application, and notifies the communication apparatus 200 of the connection configuration information. Moreover, in step S406, the terminal apparatus 100 transmits the communication connection request to the communication apparatus 200.

In step S407, the communication apparatus 200 determines a PDU session based on the communication connection request, and requests the 5GC to establish the determined PDU session. In step S408, the 5GC returns a PDU session establishment response. Through the processing described above, in step S409, connection between the terminal apparatus 100 and the 5GC (in the narrow sense, a data network beyond the 5GC) is established.

As illustrated in FIG. 7, the connection configuration information is used in the first communication between the communication apparatus 200 and the 5GC. Thus, the first communication therebetween can be communication using the 5G capabilities at the maximum. For example, in the first communication, a slice or QoS appropriate for the application activated in the terminal apparatus 100 is used. Note that, in the present embodiment, a configuration related to second communication between the terminal apparatus 100 and the communication apparatus 200 is not particularly mentioned. Thus, for example, in the second communication, WiFi connection using a default configuration is used.

As described above, the controller 210 of the communication apparatus 200 performs the second communication with the terminal apparatus 100 supporting both of the first communication method and the second communication method via the second communication unit 240, and thereby acquires the connection configuration information in the first communication method. Note that, as illustrated in FIG. 1A, the terminal apparatus 100 has the function of performing communication in accordance with the first communication method, but does not perform the communication. The controller 210 performs control of performing the first communication with a device other than the terminal apparatus 100 via the first communication unit 230, using a configuration according to the connection configuration information.

According to the method of the present embodiment, even in a case that the terminal apparatus 100 supporting the first communication method does not directly perform the first communication, by transferring the connection configuration information for the first communication to the communication apparatus 200, the communication apparatus 200 can be made to perform the first communication using the configuration desired by the terminal apparatus 100. Specifically, in the state illustrated in FIG. 1A, communication between the communication apparatus 200 and the 5GC can be made to comply with the feature of the terminal apparatus 100. As a result, even in a case that the terminal apparatus 100 does not directly perform communication of 5G, the functions of 5G can be appropriately utilized according to the application of the terminal apparatus 100.

For example, in a case that the application of the terminal apparatus 100 transmits and/or receives given data to and/or from a data network, the data is transmitted and/or received using WiFi connection between the terminal apparatus 100 and the communication apparatus 200, and is transmitted and/or received using 5G connection of the configuration appropriate for the application between the communication apparatus 200 and the 5GC. In the method of the present embodiment, the connection configuration information can be determined for each application. Thus, in a case that the same terminal apparatus 100 transmits and/or receives data but an application to be activated is different, a different communication configuration is used in the first communication between the communication apparatus 200 and the 5GC. As a matter of course, in the method of the present embodiment, the connection configuration information can be acquired for each terminal apparatus 100. Thus, even in a case that the communication apparatus 200 simultaneously connects to multiple terminal apparatuses 100, a communication configuration can be switched between the communication apparatus 200 and the 5GC, depending on correspondence between target data and an application in a terminal apparatus 100. Note that, in 5G, one UE can use multiple network slices, and multiple QoS flows can be configured as well. Thus, even in a case that each of the number of terminal apparatuses 100 and the number of applications to be activated is more than one, the communication apparatus 200 can perform communication control according to each terminal apparatus 100 and application. Note that the method of the present embodiment may employ a configuration in which the connection configuration information to be used in the first communication method can be transferred to the communication apparatus 200 using the second communication method, and a specific communication method is not limited to the example described above. In other words, the first communication method may be a method other than 5G, and the second communication method may be a method other than WiFi.

The terminal apparatus 100 of the present embodiment includes the first terminal communication unit 130 that performs the first communication using the first communication method, the second terminal communication unit 140 that performs the second communication using the second communication method different from the first communication method, and the terminal controller 110 that controls the first terminal communication unit 130 and the second terminal communication unit 140. In a state in which the first communication using the first terminal communication unit 130 is not performed, the terminal controller 110 transmits the connection configuration information to be used in a case that the communication apparatus 200 performs the first communication with another apparatus to the communication apparatus 200 via the second terminal communication unit 140 (Step S405 of FIG. 7). In this manner, even in a case that the terminal apparatus 100 itself does not perform the first communication, the connection configuration information can be transferred to the communication apparatus 200. As a result, in the first communication between the communication apparatus 200 and another apparatus, a desired configuration in compliance with the feature of the terminal apparatus 100 can be used.

The second terminal communication unit 140 of the terminal apparatus 100 transmits the acquisition request for the network information to the communication apparatus 200 (Step S402 of FIG. 7), and in response to the acquisition request, acquires information for identifying whether or not the communication method of the communication apparatus 200 on the Wide Area Network (WAN) side is the first communication method as the network information (Step S403). In a case that the network information is information indicating the first communication method, the second terminal communication unit 140 transmits the connection configuration information to the communication apparatus 200 (Step S405).

The terminal apparatus 100 of the present embodiment may first confirm whether or not the communication apparatus 200 being a connection destination in the second communication supports the first communication method using the network information, and then transmit the connection configuration information to the communication apparatus 200. In this manner, in a case that the connection configuration information can be used effectively, the connection configuration information can be transmitted to the communication apparatus 200.

The method of the present embodiment can be applied to a communication system including the terminal apparatus 100 and the communication apparatus 200. In this manner, transmission of the connection configuration information and the first communication using the connection configuration information can be performed, and thus even in a case that the communication apparatus 200 relays communication between the terminal apparatus 100 and another device, an appropriate configuration can be used.

The method of the present embodiment can be applied to a communication control method including the following steps. The communication control method is a communication control method in the communication apparatus 200 capable of performing the first communication using the first communication method and the second communication using the second communication method different from the first communication method, and includes performing the second communication using the second communication method with the terminal apparatus 100 supporting both of the first communication method and the second communication method, and thereby acquiring the connection configuration information in the first communication method, and performing the first communication with a device other than the terminal apparatus 100, using a configuration according to the connection configuration information.

A part or all of the processing performed by the terminal apparatus 100 or the communication apparatus 200 of the present embodiment may be implemented with a program. The program according to the present embodiment can be stored in a non-transitory information storage apparatus (information storage medium), which is a computer-readable medium, for example. The information storage apparatus can be implemented with an optical disc, a memory card, an HDD, a semiconductor memory, or the like, for example. The semiconductor memory is a ROM, for example. The terminal controller 110 of the terminal apparatus 100 or the controller 210 of the communication apparatus 200 performs various processes of the present embodiment, based on the program stored in the information storage apparatus. In other words, the information storage apparatus stores the program for causing a computer to function as each unit of the terminal controller 110 and the controller 210. The computer is an apparatus including an input apparatus, a processing unit, a storage unit, and an output unit. Specifically, the program according to the present embodiment is a program for causing the computer to perform each step described above with reference to FIG. 4 to FIG. 7 and the like.

### 2. Second Embodiment

In the method of the present embodiment, the controller 210 of the communication apparatus 200 may perform control of acquiring second connection configuration information being a configuration in the second communication based on the connection configuration information, and performing the second communication with the terminal apparatus 100 via the second communication unit 240, using a configuration according to the second connection configuration information. In this manner, the configuration in the second communication between the communication apparatus 200 and the terminal apparatus 100 can be controlled in compliance with the configuration in the first communication between the communication apparatus 200 and the 5GC. In other words, the configuration of the first communication and the configuration of the second communication can be synchronized.

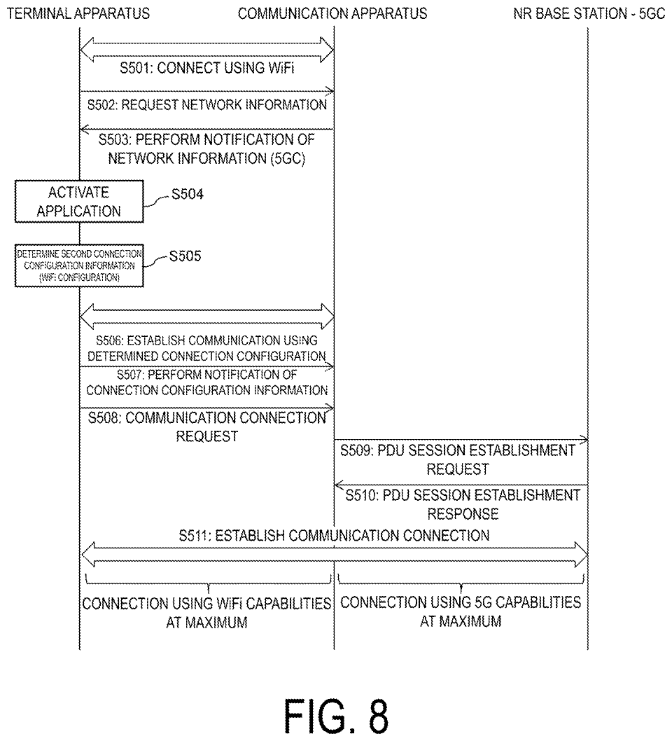

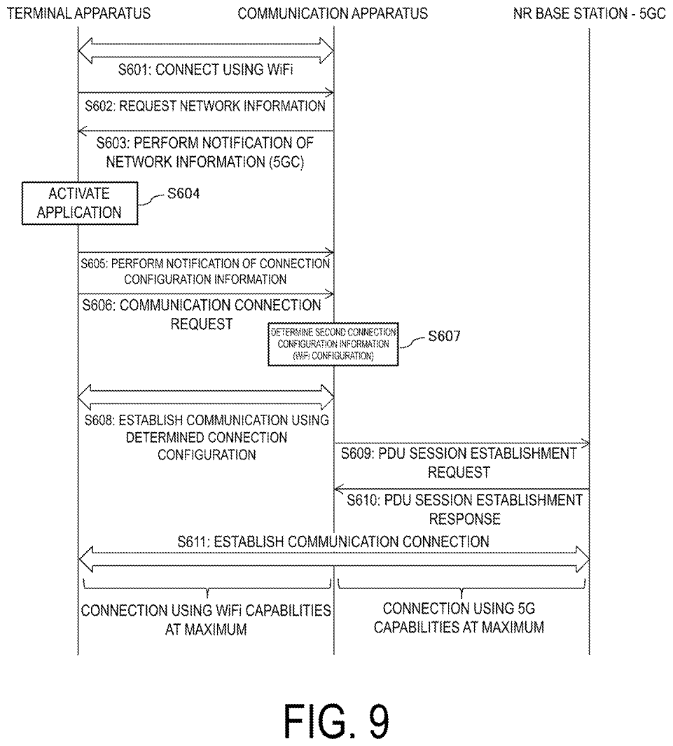

In this case, the controller 210 of the communication apparatus 200 may acquire the second connection configuration information from the terminal apparatus 100, using the second communication. In other words, the terminal apparatus 100 may perform control of determining the second connection configuration information. The controller 210 of the communication apparatus 200 may perform control of determining the second connection configuration information, based on the connection configuration information. In the following, a flow of processing of acquiring the second connection configuration information on the terminal apparatus 100 side will be described with reference to FIG. 8, and a flow of processing of acquiring the second connection configuration information on the communication apparatus 200 side will be described with reference to FIG. 9.

FIG. 8 is a diagram illustrating processing of the present embodiment. Steps S501 to S504 of FIG. 8 are the same as steps S401 to S404 of FIG. 7. In other words, WiFi connection is performed between the terminal apparatus 100 and the communication apparatus 200, and the communication apparatus 200 returns the network information for identifying the first communication method to the terminal apparatus 100, based on a request from the terminal apparatus 100. The terminal apparatus 100 activates a certain application.

As described above in the first embodiment, for example, the terminal storage unit 120 of the terminal apparatus 100 stores an application and the connection configuration information appropriate for the application in association with each other. In other words, in a case that the processing of step S504 is performed, the terminal controller 110 (connection configuration information transmission processing unit 113) can identify the connection configuration information.

Thus, in step S505, the terminal controller 110 determines the second connection configuration information. Here, the second connection configuration information may be information for determining a communication band or Quality of Service (QOS) in the second communication. For example, in a case that the second communication method is a method in accordance with IEEE 802.11, IEEE 802.11e is established as a standard for implementing QoS.

IEEE 802.11e uses a method referred to as Enhanced Distributed Channel Access (EDCA), for example. In EDCA, packets are classified into multiple access categories, and the packets are transmitted according to priority of each access category. For example, there are four access categories, and four stages of priority can be configured. In EDCA, a minimum value and a maximum value of a Contention Window (CW) can be configured according to priority. The CW is a parameter for determining a transmission standby time, and thus as the priority is higher, the CW is smaller. In other words, in Listen before talk (LBT), as the priority is higher, an LBT length (standby time) is configured to be shorter. IEEE 802.11e may use Hybrid coordination function Controlled Channel Access (HCCA). In HCCA, an access point transmits a control frame to the terminal, and only the terminal that has obtained the transmission right with the control frame can use a channel only for a period of time specified by the control frame. In other words, priority of communication can be controlled based on an assignment frequency of the transmission right and the transmittable time. In the present embodiment, the communication apparatus 200 transmits the control frame to the terminal apparatus 100. The communication apparatus 200 may be capable of controlling the communication band for each client terminal in the second communication. The control of the communication band may be control of a communication rate, may be control of a maximum volume of communication allowed within a prescribed period of time, or may be control of a frequency band used in the communication.

For example, in a case that the second connection configuration information is information indicating four stages of priority in EDCA and the connection configuration information is the 5QI value, the terminal controller 110 determines the second connection configuration information, based on the 5QI value. For example, each 5QI value is associated with a priority level, and thus the terminal storage unit 120 stores information in which the priority levels are classified into the four stages in advance. Then, in a case that the 5QI value of the connection configuration information is determined, the terminal controller 110 determines to which stage, among the four stages, the corresponding priority level belongs, and according to results of the determination, determines the priority in EDCA as the second connection configuration information. The same holds true for the case that the second connection configuration information employs HCCA, and the terminal controller 110 determines, as the second connection configuration information, control information indicating that as the priority level for the 5QI value is higher, the assignment frequency of the transmission right is higher, the transmittable time is longer, or both of these, for example. The second connection configuration information may be information indicating the communication rate allowed for each terminal apparatus 100 or application.

In a case that the connection configuration information is information for specifying a specific network slice, the terminal controller 110 determines such second connection configuration information as to have higher priority of communication, in comparison to a case that there is no specification of the network slice. For example, in a case that the connection configuration information is information for specifying a slice for one of eMBB, URLLC, and MIoT, the terminal controller 110 determines the second connection configuration information so that the priority in EDCA is higher, in comparison to a case that a slice other than the slice is specified or a case that there is no specification of the slice. Note that the network slice can employ a configuration that combines various elements, such as a communication rate, reliability, and latency, in a complex manner, and thus it is considered that it may be difficult to control these depending on the second communication method. Thus, the terminal controller 110 may perform control of determining the second connection configuration information in a case that the connection configuration information is information for specifying QoS, and may omit the control of determining the second connection configuration information in a case that the connection configuration information is information for specifying a network slice.

As described above, the connection configuration information and the second connection configuration information according to the connection configuration information can be associated with each other. Thus, for example, the terminal storage unit 120 of the terminal apparatus 100 stores information in which the connection configuration information and the second connection configuration information are associated with each other. The terminal controller 110 determines the second connection configuration information, based on the connection configuration information identified based on the activated application and the information stored in the terminal storage unit 120. After the second connection configuration information is determined, in step S506, the second communication based on the second connection configuration information is established between the terminal apparatus 100 and the communication apparatus 200. For example, the second terminal communication unit 140 and the second communication unit 240 may disconnect the WiFi connection illustrated in step S501 and then reestablish connection of different configuration, or may maintain the connection of step S501 and update only the connection configuration.

The processing of steps S507 to S510 of FIG. 8 is the same as that of steps S405 to S408 of FIG. 7, and for example, selection and establishment of a PDU session corresponding to the application are performed based on the connection configuration information.

Through the processing up to step S510, in step S511, connection between the terminal apparatus 100 and the 5GC (in the narrow sense, a data network beyond the 5GC) is established. In the present embodiment, as illustrated in steps S505 and S506, the second communication is established using the second connection configuration information. Thus, for example, in a case that the second communication method is a WiFi method, the second communication using functions of WiFi is implemented. The first communication between the communication apparatus 200 and the 5GC can use the functions of 5G, similarly to FIG. 7. For example, because it is possible to configure the QoS to be high in the first communication and also configure the QoS to be high in the second communication, the communication configuration from the terminal apparatus 100 to the 5GC may be a configuration appropriate for the terminal apparatus 100 (specifically, the application).

FIG. 9 is a diagram illustrating processing of a case that the communication apparatus 200 determines the second connection configuration information. Steps S601 to S606 of FIG. 9 are the same as steps S401 to S406 of FIG. 7. In other words, notification of the network information to the terminal apparatus 100, activation of an application in the terminal apparatus 100, transmission of the connection configuration information to the communication apparatus 200, and the like are performed.

In step S607, the controller 210 of the communication apparatus 200 determines the second connection configuration information, based on the connection configuration information acquired in step S605. For example, in a case that the processing illustrated in FIG. 9 is performed, the storage unit 220 of the communication apparatus 200 stores information in which the connection configuration information and the second connection configuration information are associated with each other. In step S607, the controller 210 determines the second connection configuration information, based on the connection configuration information acquired from the terminal apparatus 100 in step S605 and the information stored in the storage unit 220. After the second connection configuration information is determined, in step S608, the second communication based on the second connection configuration information is established between the terminal apparatus 100 and the communication apparatus 200.

Steps S609 and S610 of FIG. 9 are the same as steps S407 and S408 of FIG. 7. Through the processing described above, in step S611, connection between the terminal apparatus 100 and the 5GC (in the narrow sense, a data network beyond the 5GC) is established. In this case as well, the second communication is established using the second connection configuration information, and thus the second communication appropriately using the functions of the second communication method is implemented.

Note that the above describes an example in which the second communication method is communication conforming to IEEE 802.11, and the QoS can be controlled based on the method conforming to IEEE 802.11e. Note that, as described above in the first embodiment, the second communication method is not limited to this, and wired LAN connection may be used, and another method such as a USB may be used. In this case, the second connection configuration information can be extended to information indicating a communication configuration in those methods.

### 3. Third Embodiment

As described above, the second communication unit 240 of the communication apparatus 200 of the present embodiment performs the second communication using the second communication method with the terminal apparatus 100 supporting both of the first communication method and the second communication method, and thereby acquires the connection configuration information in the first communication method. In the above description, an example is described in which the terminal apparatus 100 determines the connection configuration information, and transmits the connection configuration information to the communication apparatus 200. In other words, “to perform the second communication, and thereby acquire the connection configuration information in the first communication method” may mean “to perform transmission and/or reception of the connection configuration information using the second communication”.

Note that the storage unit 220 of the communication apparatus 200 may store identification information for identifying the terminal apparatus 100 and the connection configuration information in association with each other. The controller 110 acquires the identification information of the terminal apparatus 100, using the second communication with the terminal apparatus 100, and reads the connection configuration information from the storage unit 220, based on the acquired identification information. In other words, “to perform the second communication, and thereby acquire the connection configuration information in the first communication method” may mean “to transmit and/or receive the identification information of the terminal apparatus 100 using the second communication, and identify the connection configuration information, based on the identification information”. Processing in this case will be described below in detail.

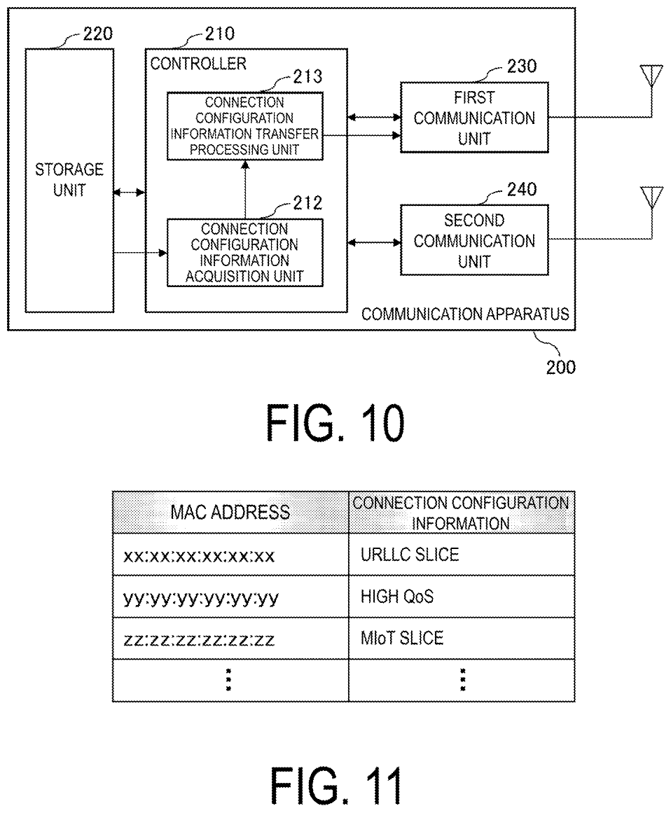

FIG. 10 is a diagram illustrating another configuration of the communication apparatus 200. The communication apparatus 200 includes the controller 210, the storage unit 220, the first communication unit 230, and the second communication unit 240. The controller 210 includes a connection configuration information acquisition unit 212 and the connection configuration information transfer processing unit 213. As can be understood from a comparison between FIG. 3 and FIG. 10, unlike the connection configuration information acquisition unit 211 of FIG. 3, the connection configuration information acquisition unit 212 of FIG. 10 acquires the connection configuration information from the storage unit 220. Other configurations are the same as that of FIG. 3.

FIG. 11 is a diagram illustrating a structure example of data stored in the storage unit 220. As illustrated in FIG. 11, the storage unit 220 stores information in which a MAC address of the terminal apparatus 100 and the connection configuration information corresponding to the terminal apparatus 100 are associated with each other. As described above, the connection configuration information may be S-NSSAI, may be a 5QI value, or may be other information. Although FIG. 11 illustrates an example in which the MAC address is used as the identification information of the terminal apparatus 100, the identification information may be information for identifying the terminal apparatus 100, and other information may be used.

The information illustrated in FIG. 11 may be input by a user of the communication apparatus 200 at the time of introducing the terminal apparatus 100, for example. For example, in a case that the communication apparatus 200 is a CPE used at home, and a user introduces a new terminal apparatus 100 into the home, the user performs processing of registering the MAC address of the terminal apparatus 100 and the connection configuration information appropriate for the terminal apparatus 100 with the communication apparatus 200. Note that specific processing is not limited to this, and the information illustrated in FIG. 11 may be acquired using another method.

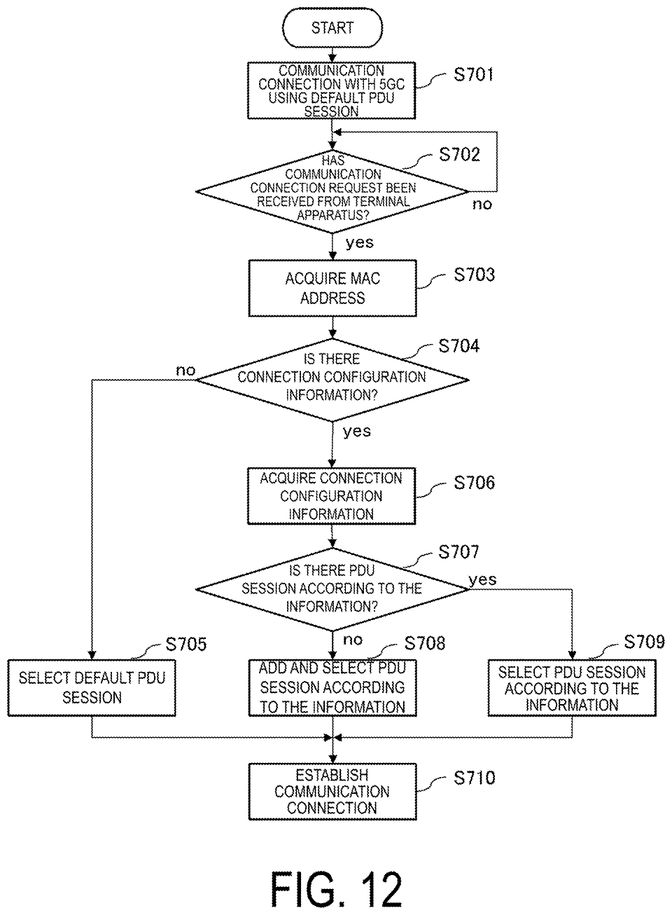

FIG. 12 is a flowchart illustrating processing of the communication apparatus 200 in the present embodiment. Steps S701 and S702 of FIG. 12 are the same as steps S201 and S202 of FIG. 5.

In a case that the communication connection request has been received from the terminal apparatus 100, in step S703, the controller 210 acquires the MAC address of the terminal apparatus 100. For example, the controller 210 identifies a transmission source MAC address included in the communication connection request as the MAC address of the terminal apparatus 100.

In step S704, the connection configuration information acquisition unit 212 determines whether the connection configuration information corresponding to the MAC address is present in the storage unit 220. Specifically, the connection configuration information acquisition unit 212 performs processing of comparing the information illustrated in FIG. 11 and the MAC address of the terminal apparatus 100 acquired in step S703. In a case that the corresponding MAC address is present in the information of FIG. 11, the connection configuration information acquisition unit 212 determines that the connection configuration information is present, whereas in a case that the corresponding MAC address is not present, the connection configuration information acquisition unit 212 determines that the connection configuration information is not present.

In a case that it is determined that the connection configuration information is not present, in step S705, the controller 210 selects a PDU session established by default. In this case, in step S710, the first communication unit 230 establishes communication connection, using the default PDU session. In other words, in a case that communication between the terminal apparatus 100 and a data network is performed, the default PDU session is used in communication between the 5GC and the communication apparatus 200.

In a case that it is determined that the connection configuration information is present, in step S706, the connection configuration information acquisition unit 212 acquires the connection configuration information. Specifically, the connection configuration information acquisition unit 212 reads the connection configuration information associated with a target MAC address from the information illustrated in FIG. 11.

Processing after acquisition of the connection configuration information is the same as that of the example of FIG. 5. Specifically, in step S707, the controller 210 determines whether a PDU session according to the connection configuration information is present. In a case that a PDU session is not established, in step S708, the controller 210 performs control of adding a corresponding PDU session, and selects the added PDU session. In a case that the slice corresponding to the connection configuration information is present, and an appropriate PDU session has been established, in step S709, the controller 210 selects the PDU session. After the processing of step S708 or step S709, the first communication unit 230 establishes communication connection, using the selected PDU session. In other words, in communication between the 5GC and the communication apparatus 200, the PDU session is determined according to the connection configuration information specified by the terminal apparatus 100.

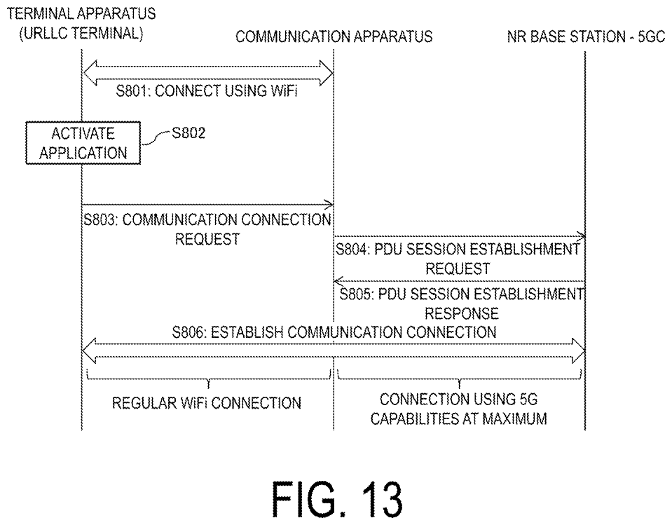

FIG. 13 is a diagram illustrating a flow of communication control between the terminal apparatus 100, the communication apparatus 200, and the 5GS (the base station 300 and the core network 400) in the present embodiment. In step S801, the terminal apparatus 100 and the communication apparatus 200 are connected using WiFi. With this, transmission and/or reception of data between the terminal apparatus 100 and the communication apparatus 200 can be performed using WiFi connection.

In step S802, the terminal apparatus 100 activates an application. In step S803, the terminal apparatus 100 transmits the communication connection request to the communication apparatus 200. As described above, the communication connection request in this case includes the MAC address, and the connection configuration information acquisition unit 212 determines the connection configuration information, based on the MAC address.

In step S804, the communication apparatus 200 determines a PDU session based on the communication connection request, and requests the 5GC to establish the determined PDU session. In step S805, the 5GC returns a PDU session establishment response. Through the processing described above, in step S806, connection between the terminal apparatus 100 and the 5GC (in the narrow sense, a data network beyond the 5GC) is established.

As illustrated in FIG. 13, the connection configuration information is used in the first communication between the communication apparatus 200 and the 5GC, and thus the first communication therebetween can be communication using the 5G capabilities. In the second communication, WiFi connection using a default configuration is used. Note that, as illustrated in FIG. 11, in the example described above, the terminal apparatus 100 and the connection configuration information are associated with each other, and the application is not taken into consideration. Thus, here, in a case that the same terminal apparatus 100 is used, the same connection configuration information may be used, despite a fact that the activated application is different.

In the present embodiment described above, in a case that the identification information of the terminal apparatus 100 can be acquired, the connection configuration information can be identified in the communication apparatus 200. For example, in WiFi connection, it is easy for the access point to acquire the MAC address of the terminal. For example, the terminal apparatus 100 can transmit the MAC address of the terminal apparatus 100 to the communication apparatus 200 being the access point while performing an authentication sequence using a Service Set Identifier (SSID) and a password. In other words, in the present embodiment, the terminal apparatus 100 need not perform dedicated processing, such as identification and transmission of the connection configuration information. Thus, any device supporting the second communication method can be used as the terminal apparatus 100 of the present embodiment. For example, as illustrated in FIG. 13, the terminal apparatus 100 may be a URLLC terminal for which high reliability and low latency are important. In this manner, the method of the present embodiment is particularly preferable in a case that the terminal apparatus 100 and the configuration (for example, a slice or QoS) appropriate for the terminal apparatus 100 correspond to each other on a one-to-one basis.

The method described above using the first embodiment and the second embodiment and the method of the third embodiment can be combined. For example, in a case that multiple terminal apparatuses 100 are used, regarding a part of terminal apparatuses 100, the connection configuration information may be determined and transmitted on the terminal apparatus 100 side as described above using the first embodiment and the second embodiment, whereas regarding other terminal apparatuses 100, the connection configuration information may be determined on the communication apparatus 200 side based on the identification information of the terminal apparatus 100 as described in the third embodiment.

### 4. Modifications

The terminal apparatus 100 may display an object representing a connection state with the core network 400 in a display unit of the terminal apparatus 100. The object in this case is a pictogram, for example. More specifically, the terminal apparatus 100 may further include a terminal display unit, which is not illustrated in FIG. 2, and the terminal controller 110 may perform control of displaying, in the terminal display unit, an object including information indicating a state of the second communication and information indicating the communication method of the communication apparatus 200 on the WAN side indicated by the network information. In this manner, in a case that the terminal apparatus 100 performs the second communication with the communication apparatus 200, a state of a network beyond the communication apparatus 200 can be appropriately notified to a user. Specific description will be given below.

The connection state of the terminal apparatus 100 includes a connection state of being connected to the core network 400 by directly performing the first communication as illustrated in FIG. 1B, and a connection state of being connected to the communication apparatus 200 using the second communication and connected to the core network 400 via the communication apparatus 200 as illustrated in FIG. 1A. In the following, for the sake of convenience of description, the state illustrated in FIG. 1B is referred to as a 5G connection state, and the state illustrated in FIG. 1A is referred to as a WiFi connection state.

Even in a case that the terminal apparatus 100 is connected to the base station 300 by performing the first communication, the terminal apparatus 100 may be connected to the 5GC or may be connected to the EPC, depending on a state of provision of a service on the core network 400 side. For example, in a case that the SA method (for example, Option 2) or some NSA methods (for example, Option 4 and Option 7) are used, the core network 400 is the 5GC, whereas in a case that other NSA methods (for example, Option 3) are used, the core network 400 is the EPC. Thus, the 5G connection state can be subdivided according to a state of the core network 400. In the following, of the 5G connection state, a state of being connected to other than the 5GC is referred to as a first connection state, and a state of being connected to the 5GC is referred to as a second connection state.

The WiFi connection state can be subdivided according to a state of the communication apparatus 200 on the WAN side. For example, the WiFi connection state may include a third connection state in which the communication apparatus 200 is connected to other than the 5GC and a fourth connection state in which the communication apparatus 200 is connected to the 5GC. For example, as illustrated in step S102 of FIG. 4, the terminal apparatus 100 acquires the network information from the communication apparatus 200. The terminal apparatus 100 can identify whether the WiFi connection state is the third connection state or the fourth connection state, based on the network information.

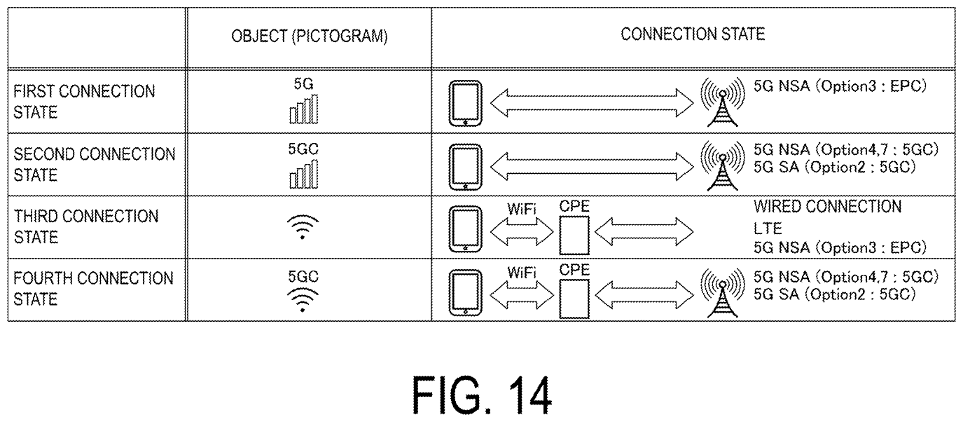

The terminal controller 110 of the terminal apparatus 100 may switch the object to be displayed, based on the connection state. FIG. 14 is a diagram illustrating an example of correspondence between the connection states and the objects (pictograms). For example, in the first connection state, the terminal controller 110 displays an object including a pictogram representing radio wave strength and text “5G”. As described above, the core network 400 in the first connection state is not the 5GC; however, because the NSA method is also a method in accordance with the 5GS standard, FIG. 14 illustrates an example for displaying such details. In the second connection state, an object including a pictogram representing radio wave strength and text “5GC” is displayed. In this manner, a fact that the core network 400 in the second connection state is the 5GC can be appropriately presented. Note that specific display is not limited to this, and for example, the terminal controller 110 may display information indicating that the core network 400 is the EPC in the first connection state.

In the third connection state, the terminal controller 110 may display a widely used pictogram representing radio wave strength of WiFi. In the fourth connection state, the terminal controller 110 may display text “5GC” in addition to a pictogram representing radio wave strength of WiFi. In this manner, in the fourth connection state, an object indicating that the first communication is performed in the communication apparatus 200 on the WAN side is displayed, and a user can thereby be appropriately presented with a fact that this is a connection state in which functions of the first communication can be used. Note that the information indicating that it is a state in which functions of the first communication can be used is not limited to the text “5GC”, and may be an icon, an image, or the like, and various modifications can be made to a specific aspect.

In a case that connection between the communication apparatus 200 and the core network 400 is established, the terminal apparatus 100 can acquire information related to a slice or QoS to be used in the connection. For example, in FIG. 7, the terminal apparatus 100 requests communication connection (Step S406). The communication apparatus 200 performs a PDU session establishment request based on the connection configuration information (Step S407), and the core network 400 determines a specific slice or QoS and performs an establishment response including information for identifying the slice or the QoS (Step S408). In other words, the communication apparatus 200 can identify the slice or the QoS to be actually used, based on the establishment response. After step S408, the communication apparatus 200 transmits information for identifying the slice or the QoS to the terminal apparatus 100.

Thus, in a case that communication connection based on the connection configuration information is established, the terminal controller 110 may acquire information for determining a network slice in network slicing of the 5GS or information for determining QoS as information of the communication apparatus 200 on the WAN side via the second terminal communication unit 140, and perform control of displaying an object corresponding to the information in the terminal display unit. In this manner, regarding communication of the communication apparatus 200 on the WAN side, more detailed information can be presented.

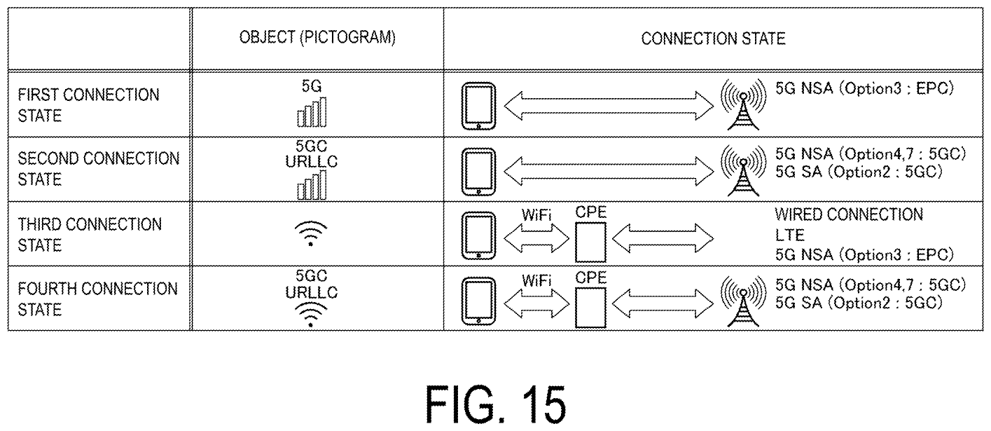

For example, the terminal controller 110 may display the object described above with reference to FIG. 14 in a case that the terminal apparatus 100 is on standby, and may display an object according to FIG. 15 in a case that the terminal apparatus 100 is in connection. For example, “in connection” refers to a state (CM-CONNECTED) in which a PDU session is established, and “on standby” refers to an idle state (CM-IDLE).

As illustrated in FIG. 15, objects displayed in the first connection state and the third connection state may be the same as those of FIG. 14. In other words, in a case that the core network 400 as a connection destination is not the 5GC, the same objects as those in the “on standby” case are displayed even in the “in connection” case. For example, the terminal controller 110 may display an object including a pictogram representing radio wave strength and text “5G” in the first connection state, and display a pictogram representing radio wave strength of WiFi in the third connection state.

In contrast, in the fourth connection state, information indicating at least one of a slice and QoS is displayed in addition to the object illustrated in FIG. 14. For example, it is assumed that a slice corresponding to URLLC is selected in connection between the communication apparatus 200 and the core network 400, and information indicating such details is transmitted to the terminal apparatus 100. In this case, in the fourth connection state, the terminal controller 110 displays an object including information indicating radio wave strength of WiFi, information indicating connection to the 5GC, and information indicating that the slice corresponding to URLLC is selected. Although FIG. 15 illustrates an example of the object including text “5GC” and “URLLC”, a specific object is not limited to this, and other information such as an image and an icon may be used.

In the second connection state, the terminal apparatus 100 directly performs the first communication as the UE, and thus the terminal apparatus 100 can receive information for identifying a slice or QoS as an establishment response from the core network 400. Thus, in the second connection state as well, the terminal controller 110 can display information indicating at least one of a slice and QoS. FIG. 15 illustrates an example of an object including text “5GC” and “URLLC” in addition to the radio wave strength of 5G.

As described above, for example, performing the display illustrated in FIG. 14 can have a user of the terminal apparatus 100 appropriately recognize whether or not it is a state in which the 5GC can be used. As illustrated in FIG. 15, displaying the information related to the slice or the QoS can enable more detailed recognition of an environment in which the terminal apparatus 100 is placed. For example, with the display indicating URLLC, the user can determine that communication of ultra-low latency can be used, and with the display indicating eMBB, the user can determine that high-speed communication of large-volume data can be used. As a result, the user can be enabled to determine whether or not an application that exerts an effect in an ultra-low latency environment can be used, for example. Particularly, in a case that the communication apparatus 200 is a device installed in a hotel, a store, or the like, it is not easy for the user of the terminal apparatus 100 to know information related to communication of the communication apparatus 200 on the WAN side in advance, and thus performing the display illustrated in FIG. 14 and FIG. 15 is effective.

Here, although an example is illustrated in which the display illustrated in FIG. 14 is performed in the “on standby” case (CM-IDLE) and the display illustrated in FIG. 15 is performed in the “in connection” case (CM-CONNECTED), the method of the present embodiment is not limited to this. For example, various modifications can be made to a specific display method by, for example, performing the display illustrated in FIG. 14 in both of the “on standby” case and the “in connection” case.

Note that, although the present embodiment has been described in detail as in the above, it shall be easily understood by a person skilled in the art that numerous modifications can be made without substantially departing from new matters and effects of the present embodiment. Accordingly, such modifications are all included within the scope of the present disclosure. For example, a term that is at least once described with a different term having a wider meaning or the same meaning in the specification or the drawings can be replaced with the different term in any part of the specification or the drawings. All of combinations of the present embodiment and the modifications are also included within the scope of the present disclosure. The configurations, the operations, and the like of the terminal apparatus, the communication apparatus, the communication system, and the like are not limited to those described in the present embodiment, and various modifications can be made thereto.

1. A communication apparatus, comprising:
a first communication unit configured to perform first communication using a first communication method;
a second communication unit configured to perform second communication using a second communication method different from the first communication method; and
a controller configured to control the first communication unit and the second communication unit, wherein
the controller performs the second communication via the second communication unit with a terminal apparatus supporting both of the first communication method and the second communication method, to acquire connection configuration information in the first communication method, and
the controller performs the first communication with a device other than the terminal apparatus via the first communication unit, using a configuration according to the connection configuration information.

2. The communication apparatus according to claim 1, wherein
the first communication method is a radio communication method used in a 5G System (5GS).

3. The communication apparatus according to claim 2, wherein
the connection configuration information is information for determining a network slice in network slicing of the 5GS or information for determining Quality of Service (QOS).

4. The communication apparatus according to claim 2, wherein
the controller performs control of determining a Protocol Data Unit (PDU) session to be used in the first communication, based on the connection configuration information.

5. The communication apparatus according to claim 1, wherein
the connection configuration information is information determined according to an application program to be performed in the terminal apparatus.

6. The communication apparatus according to claim 1, wherein
the controller acquires second connection configuration information being a configuration in the second communication, based on the connection configuration information, and performs the second communication with the terminal apparatus via the second communication unit, using a configuration according to the second connection configuration information.

7. The communication apparatus according to claim 6, wherein
the second connection configuration information is information for determining Quality of Service (QOS) or a communication band in the second communication.

8. The communication apparatus according to claim 6, wherein
the controller performs control of acquiring the second connection configuration information from the terminal apparatus using the second communication or determining the second connection configuration information based on the connection configuration information.

9. The communication apparatus according to claim 1, further comprising
a storage unit configured to store identification information for identifying the terminal apparatus and the connection configuration information in association with each other, wherein
the controller acquires the identification information of the terminal apparatus, using the second communication with the terminal apparatus, and
the controller reads the connection configuration information from the storage unit, based on the identification information.

10. A terminal apparatus comprising:
a first terminal communication unit configured to perform first communication using a first communication method;
a second terminal communication unit configured to perform second communication with a communication apparatus, using a second communication method different from the first communication method; and
a terminal controller configured to control the first terminal communication unit and the second terminal communication unit, wherein
in a state in which the first communication using the first terminal communication unit is not performed, the terminal controller transmits connection configuration information to be used in a case that the communication apparatus performs the first communication with another apparatus to the communication apparatus via the second terminal communication unit.

11. The terminal apparatus according to claim 10, wherein
the second terminal communication unit transmits an acquisition request for network information to the communication apparatus,
in response to the acquisition request, the second terminal communication unit acquires information for identifying whether or not a communication method of the communication apparatus on a Wide Area Network (WAN) side is the first communication method, as the network information, and
in a case that the network information is information indicating the first communication method, the second terminal communication unit transmits the connection configuration information to the communication apparatus.

12. The terminal apparatus according to claim 11, further comprising
a terminal display unit, wherein
the terminal controller performs control of displaying, in the terminal display unit, an object including information indicating a state of the second communication and information indicating the communication method of the communication apparatus on the WAN side indicated by the network information.

13. The terminal apparatus according to claim 12, wherein
the first communication method is a radio communication method used in a 5G System (5GS),
the terminal controller acquires information for determining a network slice in network slicing of the 5GS or information for determining Quality of Service (QOS), as the information of the communication apparatus on the WAN side via the second terminal communication unit, and
the terminal controller performs control of displaying an object including information indicating the network slice or the QoS in the terminal display unit.

14. A communication system comprising:
a communication apparatus configured to perform communication using a first communication method and a second communication method; and
a terminal apparatus configured to perform communication using the first communication method and the second communication method, wherein
the communication apparatus performs second communication using the second communication method with the terminal apparatus not performing communication using the first communication method, to acquire connection configuration information in the first communication method, and
the communication apparatus performs first communication using the first communication method with a device other than the terminal apparatus, using a configuration according to the connection configuration information.

15. A communication control method in a communication apparatus configured to perform first communication using a first communication method and second communication using a second communication method different from the first communication method, the communication control method comprising:
performing the second communication using the second communication method with a terminal apparatus supporting both of the first communication method and the second communication method, to acquire connection configuration information in the first communication method; and
performing the first communication with a device other than the terminal apparatus, using a configuration according to the connection configuration information.
